(19) United States
(12) Patent Application Publication
(10) Pub. No.: US 2008/0027822 A1
(43) Pub. Date: Jan. 31, 2008

(54) METHOD AND APPARATUS FOR ELECTRONIC LITERARY MACRAME BUSINESS DEVELOPMENT

(76) Inventor: Dana W. Paxson, Rochester, NY (US)

Correspondence Address: HISCOCK & BARCLAY, LLP, 2000 HSBC PLAZA, 100 Chestnut Street, ROCHESTER, NY, 14604-2404, US

(21) Appl. No.: 11/828,010

(22) Filed: Jul. 25, 2007

Related U.S. Application Data
(60) Provisional application No. 60/833,201, filed on Jul. 25, 2006.
(60) Provisional application No. 60/909,197, filed on Mar. 30, 2007.

(30) Foreign Application Priority Data
Feb. 26, 2007 (US) PCT/US07/62801

(51) Int. Cl. G06Q 30/00

(52) U.S. Cl. 705/26

(57) ABSTRACT

A business method that divides an electronic literary macramé (ELM) or knowledge transfer tool (KTT) output into a freely-provided first part and a purchased second part, and provides hypertext links between the first and second parts. The reader obtains the first part by file transfer, streaming, download, portable memory, or other electronic means. The author maintains, develops, changes, and restructures the second part of the ELM/KTT on a continuing basis, thereby sustaining reader interest in the ELM/KTT as a whole, and offering the reader continued views into the creative process.

Individual scenes or units of the purchased second part are treated as commodity units available on a commercial Website for sale and download, or available in a variety of physical forms. Readers assemble freely-provided units and commodity units into otherwise-unavailable coherent narratives.

### REFERENCE TO RELATED APPLICATIONS

This application claims the benefit of U.S. Provisional Application No. 60/833,201, filed Jul. 25, 2006, and U.S. Provisional Application No. 60/909,197, filed Mar. 30, 2007, both of which are hereby incorporated by reference. This application also claims the benefit of PCT Application No. PCT/US2007/062801, filed Feb. 26, 2007, which is hereby incorporated by reference. Reference is also made to the following related applications: U.S. Nonprovisional application Ser. No. 11/361,439, filed Feb. 24, 2006, entitled “Apparatus and Method for Creating Literary Macramés”; U.S. Nonprovisional application Ser. No. ______, filed ______, entitled “Method and Apparatus for Digital Watermarking for Electronic Literary Macramé,” attorney docket no. 305466-301883US02; U.S. Nonprovisional application Ser. No. ______, filed ______, entitled “Method and Apparatus for Electronic Literary Macramé Component Referencing,” attorney docket no. 305466-301883US03; and U.S. Nonprovisional application Ser. No. ______ filed ______, entitled “Method and Apparatus for Presenting Electronic Literary Macramé on Handheld Computer Systems,” attorney docket no. 305466-301883US04, all of which are hereby incorporated by reference.

### AREA OF INVENTION

This disclosure relates to the creation of texts readable on computers, and more specifically to the arrangement and deployment for commercial purposes of interconnected narratives and references readable using browser programs such as those adapted for use on the World Wide Web.

### BACKGROUND OF INVENTION

To illustrate and provide background for the present method and apparatus, the patent application titled “Apparatus and Method for Creating Literary Macramés”, U.S. patent application Ser. No. 11/361,439, by the present inventor, is incorporated herein by reference. A literary macramé, also called here an ‘ELM’, or electronic literary macramé, is a form of text offering readers advantages over other forms of literature in referencing and tracing connections.

To provide further background and support for the present method and apparatus, the patent application titled “The Knowledge Transfer Tool: An Apparatus And Method For Knowledge Transfer”, International Application No. PCT/US2007/062801, also by the present inventor, is also incorporated herein by reference. The Knowledge Transfer Tool, also called here a ‘KTT’, combines ELM characteristics and capabilities with rule-based expert system and programmed-instruction components to allow authors to produce immersive learning programs in literary and textbook forms on electronic media.

To provide context for ongoing developments relating to the present method and apparatus, the patent applications titled “Method And Apparatus For Electronic Literary Macramé Component Referencing”, “Method For Presenting Electronic Literary Macramés On Handheld Computer Systems”, and “Method And Apparatus For Digital Watermarking For The Electronic Literary Macramé”, also by the present inventor, are additionally incorporated herein by reference.

Making money from publishing is a precarious business, and making money from electronic publishing has generally resembled leaping from an airplane without a parachute: far more than precarious. Although electronic publishing has great advantages over print publishing in eliminating inventory and distribution costs, it has not caught on with readers in sufficient numbers to render it profitable, and the ease with which electronic works can be illegally copied and distributed is a nightmare for anyone concerned with protection of copyright. This problem exists also for computer software, and software vendors have attempted many innovative solutions to it. Some of these solutions, particularly the “give away the razor and sell the blades” approach, have actually worked fairly well.

Early experience with browsers and continuing antivirus subscription approaches show that variations of a giveaway strategy create bonds between the user of the free software and services and the supplier's sale of additional components that enhance, enrich, maintain, or improve the products or services freely provided. In the realm of literature, author Stephen King has attempted to furnish electronic fiction for reading on a chapter-by-chapter basis as called for by readers. Numerous electronic publishers furnish “electronic books” for download in all segments of the publishing market, and the number and type of approaches to presentation and sale of such literature have grown explosively.

### DESCRIPTION OF DRAWINGS

FIG. 1 shows an overview of the components and processing of the present method and apparatus.

FIG. 2 shows an overview of the computer structures of the present apparatus.

FIG. 3 shows the overall process for updating and selling the ELM/KTT using the present method and apparatus.

FIG. 4 shows the deployment of ELM/KTT components for an original document.

FIG. 5 shows the deployment of ELM/KTT components for an updated document.

FIG. 6 shows the deployment of ELM/KTT components for the updates to a document.

FIG. 7 shows the ELM/KTT linking process between updated and original documents.

FIG. 8 shows the process for selling components of an ELM/KTT.

FIG. 9 shows the process for selling a complete updated ELM/KTT.

### SUMMARY

The present business method and an apparatus divide an electronic literary macramé (ELM) or knowledge transfer tool (KTT) output into a freely-provided first part and a purchased second part, and provide hypertext links between the first and second parts. The reader obtains the first part by file transfer, streaming, download, portable memory, or other electronic means. When the reader selects a link in the first part that accesses the second part, the reader's browser is redirected to a Web page soliciting purchase, lease, or other payment for access to the second part. The author maintains, develops, changes, and restructures the second part of the ELM/KTT on a continuing basis, thereby sustaining reader interest in the ELM/KTT as a whole, and offering the reader continued views into the creative process. An author may also use the present method and apparatus to advertise to readers new versions of the ELM/KTT as a whole, made available for download or other transfer process as the author considers appropriate.

In a trading embodiment, the present method and apparatus treat individual scenes or units of the purchased second part as commodity units, which are handled in a manner analogous to trading cards such as the Yu-Gi-Oh cards and other similar objects. An ELM/KTT author makes disconnected scenes or units available on a commercial Website for sale and download, and these scenes or units are assembled by the reader into a coherent narrative. The actual sequence of the narrative, or more than one such sequence, is also made available for sale and download by the author. In effect, an ELM/KTT narrative is assembled and added to an ELM/KTT using these means.

In addition to or as an alternative to electronic presentation of scenes or units, the present method and apparatus provide physical presentations of scenes or units in the form of trading cards, individual or in packets, which add to the content and value of a narrative published as a component of an ELM/KTT.

By applying this particular strategy to works of literature in an ongoing state of development, the ELM/KTT offers the publisher substantial reductions of risk in publishing, and potential gains in profits from works sold.

### DETAILED DESCRIPTION OF THE INVENTION

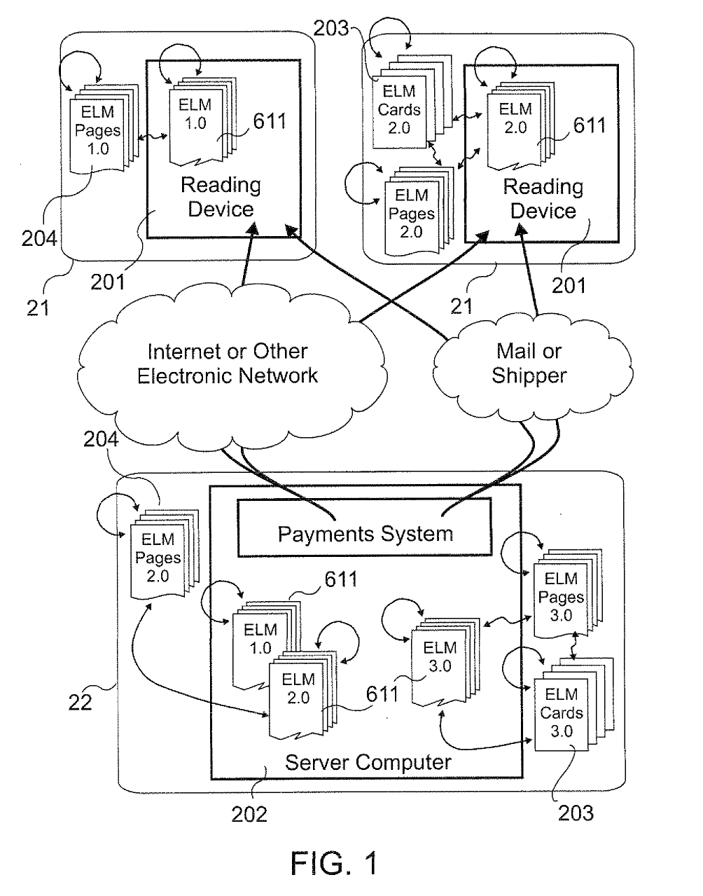

See FIG. 1. The present apparatus comprises a plurality of computer systems 201, 202, at respective locations 21, 22. Each computer system 201 comprises a client computer system used as a device for reading electronic documents 611. Each computer system 202 comprises a server computer system used for providing electronic documents 611 to client computer systems 201.

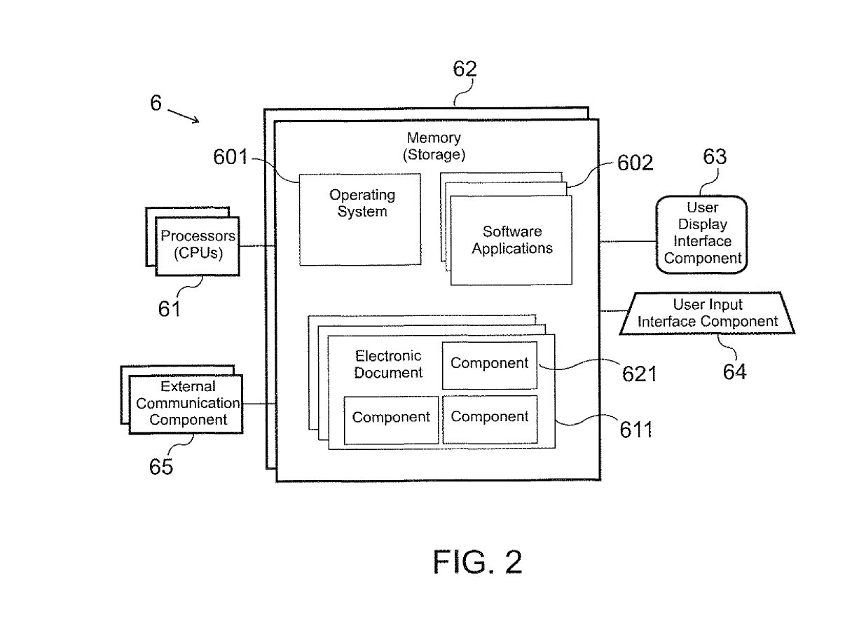

See FIG. 2. Each computer system 201, 202 of the present apparatus comprises a computer 6, made up of one or more processors (CPUs) 61, a user display interface component 63 such as a CRT, flat-panel display, or other viewing device, one or more user input interface components 64 such as a keyboard, a mouse, a touch panel, a scribing device such as a stylus, or some other pointing, selection, or data entry device, an external communications component 65, and one or more memory components 62. Any of the memory components 62 may hold an operating system 601 one or more software applications 602, and one or more electronic documents 611. Each electronic document 611 comprises a plurality of components 621.

The software applications 602 of the present apparatus comprise

The ELM/KTT offers opportunities for authors, publishers, and literary trustees to sell, lease, or otherwise provide access to components of the ELM/KTT which cannot be provided by the download of a set of files. A provider of an ELM/KTT in file form may profit from the provision of that ELM/KTT, in whole or in part, to a buyer, subscriber, or lessee.

The provision of files alone as the complete content of an ELM/KTT offers little opportunity by itself for profit, and much risk from unauthorized copying of its files to create new copies. Even though the ELM/KTT may be watermarked or otherwise identified on a per-copy basis (see U.S. patent application titled “Method And Apparatus For Digital Watermarking For The Electronic Literary Macramé”), no profit can be realized from copies spawned from such an ELM/KTT without expending more than the potential profit in the process of pursuing it. Therefore the present method and apparatus exploit the ELM/KTT's additional characteristics.

The first benefit of the ELM/KTT in contrast to ordinary print and electronic literature is its use of standard hypertext markup language (HTML) in ways that enrich a reader's experience without reducing the reader's immersion in the work. The use of HTML or its extensions such as XHTML allows the author or publisher to embed links in the ELM/KTT which connect the reader to a Web server on the Internet. The Internet is increasingly accessible in many places. Also, the ELM/KTT can be used on a widening range of handheld Web-enabled devices such as the Sony PSP and the Palm T/X, further widening access to Internet resources (see U.S. patent application titled “Method For Presenting Electronic Literary Macramés On Handheld Computer Systems”). These factors facilitates the connection of the reader to one or more Websites offering content that further supports and enriches the ELM/KTT. FIG. 1 shows an overview of the process.

For readers who enjoy the immersive experience of reading an ELM/KTT, the availability of additional material augmenting that experience is attractive. An example familiar in the world of print publishing is the worldwide sales of J. R. R. Tolkien's “The History of Middle-Earth”, a twelve-volume set of books providing for readers earlier unpublished versions of the tales published in the books of “The Lord of the Rings” and “The Silmarillion”. Such material has proved quite attractive to readers, even though it does not attain the level of the wildly-popular works generated from it. Illustrating the attractive power of additional material, the publishers of Tolkien's works continue to roll out books derived from the author's earlier and unfinished manuscripts, the latest being “The Children of Hurin”.

In general, readers enjoy connecting with other people and places where they can find more enrichment of the works they read, and the ELM/KTT makes such connections easier. The present method and apparatus exploit such attractive engagements in two ways: charging the reader for access to supporting additional material, and the separating of such additional material into scenes or units that become objects for trade in either a physical form or an electronic form.

### Charging for Additional Material

The present method and apparatus enable an author who develops and publishes an ELM or a KTT to establish a source Website on which the author places additional material not in the distributed set of files that comprise the issued ELM/KTT itself. A reader of such an ELM/KTT clicking on a link in the ELM/KTT during reading opens an Internet connection to its source Website where the present method and apparatus make an offer of special material, for an appropriate fee to be paid by the reader. The present method and apparatus identify clearly such links to avoid irritating readers who don't want to get such offers. This class of link is stored in the ELM/KTT at the time the ELM/KTT is generated and downloaded, forestalling any need to update the ELM/KTT to contain the links to Websites.

The present method and apparatus provide similar links without charge, each such link giving readers a preview of related works, stories in progress, sequels, prequels, or other enriching information of value in relation to the ELM/KTT.

In other remote-link-enabled embodiments, a Web site link of the present method and apparatus takes a reader to a discussion board or a chatroom to socialize or exchange information with other readers. A further embodiment of remote links offers the reader Website tie-ins with related products such as games and gamesites, films, music, and art. Such links may be made freely available or for-pay as desired by their providers.

The present method and apparatus gate access to such Websites in different embodiments so as to charge a reader for access to material not otherwise supplied in the ELM/KTT. Many profit models are known in the art. A subscription-model embodiment requires a subscription fee to allow a specific reader to retrieve and display ELM/KTT supplements. A second embodiment requires a micropayment for each such access. A third embodiment employs a single-payment approach in which the reader pays a one-time fee and from that point on has access privileges to a range of site content. These embodiments may be combined in various ways to meet different business needs.

The subscription-model embodiment works as follows. The reader of an ELM/KTT selects a link which directs the reader's browser to a subscription Webpage. The subscription Webpage displays an offer to the reader for a subscription to receive periodic updates concerning the ELM/KTT being read. The reader may select a subscription option, may choose a no-fee page for display, or may decline the offer and be returned to a page within the ELM/KTT itself. If the reader chooses a subscription option, the Website conducts a dialog to establish payment transfer, and then presents the reader with content integrated with the ELM/KTT such as a reference article, a chapter draft, a glossary entry, a music or video stream, or any other class of digital content. Such content may either be streamed for one-time presentation, or downloaded for permanent integration with the ELM/KTT in the reader's system.

The subscription-model embodiment gives authors and publishers the unique ability to admit the reader to the creative process for an ELM/KTT. Due to the many-threaded character of the ELM/KTT, some story or narrative threads may be left incomplete at the time of the ELM's initial publication without compromising the main narrative lines. These incomplete threads may end in links to the author's Website which give the reader access to new sections of narrative as the author completes them. By providing such access through a controlled Website, the author or publisher can determine exactly which new pieces of content may be revealed to readers, and can realize profit from making them available. The present disclosure thereby offers a powerful attractant to readers for paying to watch the author at work.

There is no reason to restrict an ELM's subscription model to a single-author framework. An ELM/KTT may have multiple authors, working in a “shared-world” mode as is done in print form in the Forgotten Realms books or others of that type. In such cases, the appeal for readers is multiplied by the number of different authors and narrative threads that can be accessed for a given work.

### Scene and Unit Trading

The present method and apparatus also offer for sale, lease, or other consideration to said readers a set of changes to the reader's ELM/KTT. Here we define a “text unit” as a scene, reference page, glossary entry, or any other identifiable component of a document which may be separately packaged and sold, including text, symbols, images, image streams, software, and combinations of said components for presenting said components. The offered changes to the reader's ELM/KTT comprise new text units, rewritten text units, deletions of text units, and relinking of text units to one another.

### Overview

See FIG. 1. The ELM/KTT already furnished to readers may comprise a combination of text units stored on the reader's reading device 201, text units stored on one or more server computer systems 202, text units stored on one or more portable memory devices 203, and text units stored in printed form 204. The present method and apparatus provide updates to any or all of these forms of text unit, in any possible combination, so that any specific text unit may be added, changed, or deleted as part of an update to an ELM/KTT. An update to an ELM/KTT is offered for sale, lease, or other consideration to the reader.

The present method and apparatus accept as its raw material a set of narrative scenes or units, descriptive passages, glossary entries, and other separable text units, all associated with one or more ELMs. The first step in the process of the present method and apparatus is to separate the input units and package them independently as standalone text units.

The second step is to connect each set of text units to an ELM/KTT. The present method and apparatus connect a text unit to an ELM/KTT by one or more of the following means:

### 1. Conventional (X) HTML linking between a first text unit and a second text unit belonging to the ELM;

### 2. Execution of a custom software program associated with a first text unit to retrieve and display a second text unit belonging to the ELM;

### 3. Visual and manual linking between a first text unit and a second text unit belonging to the ELM/KTT as is conventionally done with printed works;

### 4. Optical or magnetic scanning of a first text unit to obtain a software link to a second text unit belonging to the ELM/KTT, and applying the scanned information to retrieve and display the second text unit;

### 5. Combinations of 1-4.

The first connection point, called the inlink, is stored as a symbolic anchor in the ELM/KTT, and a symbolic link to that anchor is installed in the standalone scene. For an explanation of symbolic links and symbolic anchors, see the patent application titled Method and Apparatus for Symbolic Linking and Directive Use in a Literary Macramé, incorporated herein by reference. Using the symbolic link in the standalone scene or unit takes the reader to an author-defined point in the ELM/KTT. If the ELM/KTT is not available to the reader, the link takes the reader to the author's Website, where the reader is presented with additional options for obtaining additional standalone scenes or units or getting an edition of the full ELM/KTT itself.

The second connection point, called the outlink, is stored as a symbolic anchor in the standalone scene, and a symbolic link to that anchor is installed in the ELM/KTT. Using the symbolic link in the ELM/KTT takes the reader of the ELM/KTT to the standalone scene or unit—if it is available to the reader. If the reader does not have the standalone scene or unit already stored within access reach of the ELM/KTT, the link takes the reader either to a standard page of the ELM/KTT presenting the reader with purchase options for the standalone scenes or units, or to the author's Website for the presentation of similar options.

The third step is the concatenation of the scenes or units in a set into one or more narrative components, each of which may comprise either a complete narrative or only a portion of a narrative. The author accomplishes this concatenation by using links in the same manner as is provided in an ELM/KTT. As in the second step, the use of any link may yield either a displayed scene or unit text or a presentation of options for obtaining further standalone scenes or units.

The fourth step is the packaging of the standalone scenes or units. Packaging is performed using conventional means for placing the text in an attractive, coherent, and entertaining setting, and insuring the text's integrity and reliability (i.e., watermarking).

The fifth step is the provision of the standalone scenes or units to readers. The World Wide Web and all of the available and developing wireless access technologies offer conventional means to pass a standalone scene or unit from an author to a reader, and from reader to reader. The author sells or otherwise provides the first copy of the standalone scene or unit to one or more readers, and those readers then pass it to others via the Internet, text messaging programs, Wi-fi networks, and micronets.

The reader's electronic reading device may be a desktop computer system, a portable computer system, a portable electronic book, a portable electronic game playing system, a personal digital assistant, a wireless telephone or any device that can present electronic text to a reader in some form either visible or audible.

The server computer system may be a desktop computer system, a portable computer system, a portable electronic book, a portable electronic game playing system, a personal digital assistant, a wireless telephone, or any device capable of presenting text for reading visually or audibly.

A portable computer memory device may be a compact flash memory chip, a memory stick, an electronic smart card, a compact disk, a DVD, a magnetic diskette, an optical memory device, or a magneto-optical memory device.

A text unit may be a digital text comprising words and symbols, a digital image, a digital audio file, a digital video file, or a software program containing electronic text components for presenting the text unit to a reader.

A printed text component may be a bound or unbound set of pages, a trading card, a mounted display, a garment, or a decorative display showing the content of the printed component.

A link may be a hypertext link between two electronic text components, a printed text referring a reader from one printed text component to another, a printed text referring a reader from a printed text component to an electronic text component, or a coded printed text readable by an electronic device linking from a printed text component to an electronic text component.

Coded printed text may be any scannable optical code familiar to practitioners in the art.

### Detailed Processing of the ELM Business Development

The present method and apparatus provide for marketing and selling components of an ELM/KTT by creating and retaining an original ELM/KTT, providing copies of the work to readers, making changes to the work to produce an updated version and a set of changes, and offering and selling the work's updated version or the changes to the readers.

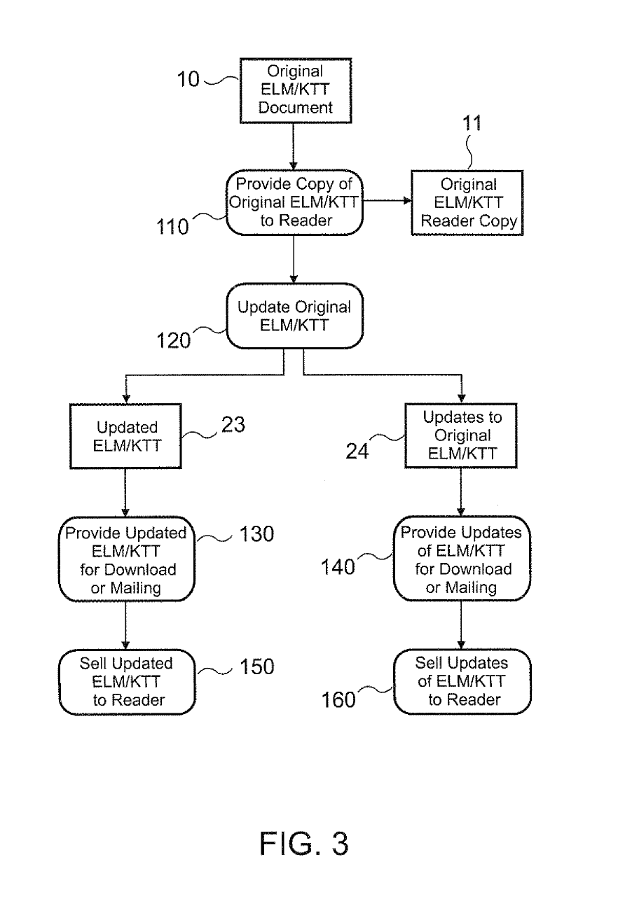

See FIG. 3. To market and sell an evolving ELM/KTT, an author or publisher uses the present method and apparatus to provide (110) copies 11 of the original ELM/KTT 10 to readers, make changes and additions (120) to the original ELM/KTT 10 to produce an updated ELM/KTT 23 and one or more sets of the changes and additions 24 to the ELM/KTT. Then the author uses the present method and apparatus to provide (130) copies of the updated ELM/KTT 23 for download or mailing, and to provide (140) copies of the changes and additions 24 to the ELM/KTT to readers. When updates and changes are available, the author then uses the present method and apparatus to sell (150) the updated ELM/KTT 23 to the readers, or alternatively to sell (160) changes and additions 24 to the original ELM/KTT to the readers.

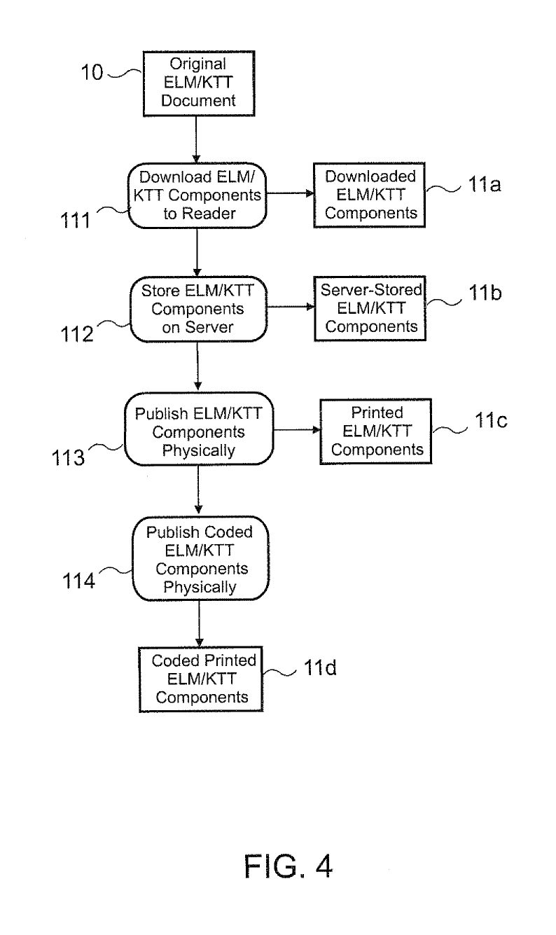

See FIG. 4. The present method and apparatus provide copies of the original ELM/KTT in several different ways, and in combinations of ways. First, the present method and apparatus may provide copies or components to readers by storing one or more components of the original ELM/KTT in a set of electronic files 11a for downloading (111) to an electronic reading device. Second, the present method and apparatus may provide copies or components by storing one or more components of the original ELM/KTT in a set of electronic files 11b for storage (112) on a server computer for remote access by an electronic reading device. Third, the present method and apparatus may store (113) one or more components of the original ELM/KTT in physical form 11c for physical transmission and reading, and fourth, it may store (114) one or more components of the original ELM/KTT in coded physical form 11d for physical transmission and electronic reading by a decoding device such as a scanner, bar code reader, or other similar device.

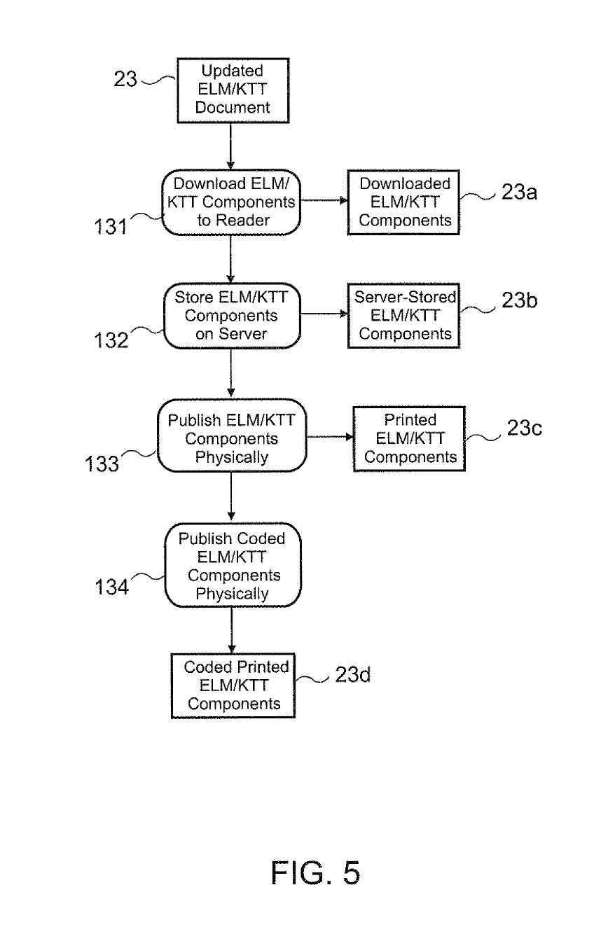

See FIG. 5. The present method and apparatus provide copies of an updated ELM/KTT in the same manner as for the original document. The present method and apparatus may store one or more components of the updated ELM/KTT in a set of electronic files 23a for downloading (131) to an electronic reading device. The present method and apparatus may store one or more components of the updated ELM/KTT in a set of electronic files 23b for storage (132) on a server computer for remote access by an electronic reading device. The present method and apparatus may further store (133) one or more components of the updated ELM/KTT in physical form 23c for physical transmission and reading. Further, the present method and apparatus may store (134) one or more components of the updated ELM/KTT in coded physical form 23d for physical transmission and reading by a decoding device. Finally, the present method and apparatus may store (135) one or more components of the updated ELM/KTT in a set of electronic files in a digital memory device 23e for physical transmission and downloading to an electronic reading device.

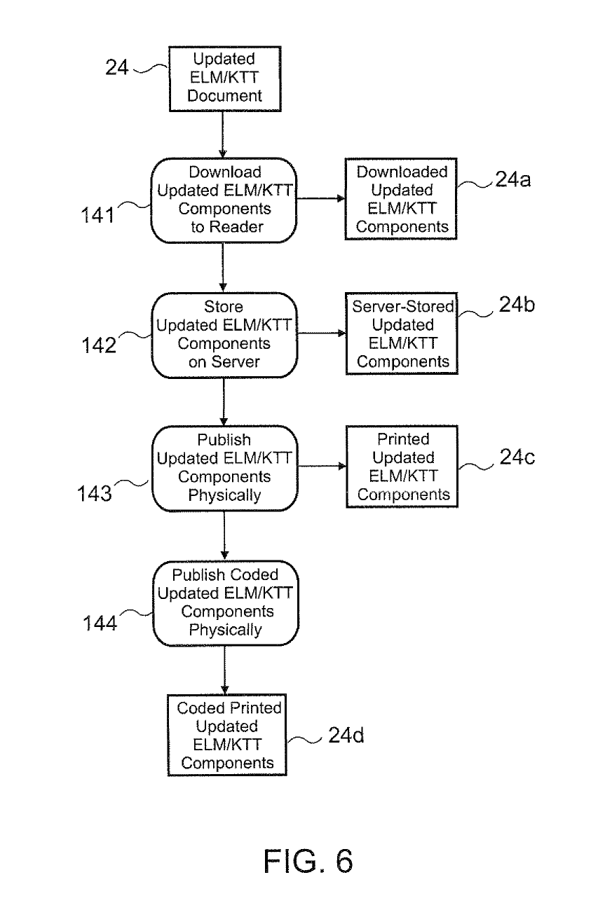

See FIG. 6. Providing changes and additions the ELM/KTT breaks down into a pattern of steps similar to those for providing a complete revised document. First, the present method and apparatus may store one or more changes to the ELM/KTT in a set of electronic files 24a for downloading (141) to an electronic reading device. Second, the present method and apparatus may store one or more changes to the ELM/KTT in a set of electronic files 24b for storage (142) on a server computer for remote access by an electronic reading device. Third, the present method and apparatus may store (143) one or more changes to the ELM/KTT in physical form 24c for physical transmission and reading, and may store (134) one or more changes to the updated ELM/KTT in coded physical form 23d for physical transmission and reading by a decoding device. Finally, the present method and apparatus may store (135) one or more changes to the ELM/KTT in a set of electronic files in a digital memory device 24e for physical transmission and downloading to an electronic reading device;

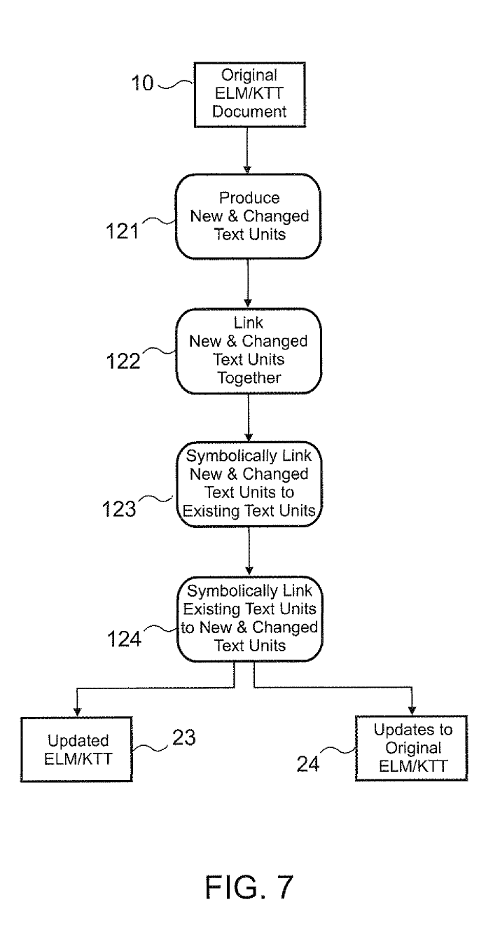

See FIG. 7. Making changes and additions to the original ELM/KTT to produce an updated ELM/KTT and one or more sets of the changes and additions to the ELM/KTT breaks down into a series of steps. First, the author prepares (121) one or more additional units of text for the original ELM/KTT 10. The present method and apparatus provide for linking (122) the one or more additional units of text to each other, linking (123) said additional units of text to the original ELM/KTT 10, and linking (124) the original ELM/KTT 10 to the additional units of text to produce the updated ELM/KTT 23 and the one or more sets of the changes and additions 24 to the ELM/KTT. Linking additional units of text to the ELM/KTT may be done by installing symbolic anchors in each ELM/KTT, and symbolic links in each additional unit of text linking to the symbolic anchors in the ELM/KTT. Likewise, linking the ELM/KTT to additional units of text may be done by installing symbolic anchors in each additional unit of text, and symbolic links in each ELM/KTT linking to the symbolic anchors in each additional unit of text.

Refer again to FIG. 7. Making changes and additions to the original ELM/KTT to produce an updated ELM/KTT and one or more sets of the changes and additions to the ELM/KTT requires revising (121) one or more units of text of said original ELM/KTT 10 sold to readers, linking (123) the revised units of text to the ELM/KTT 10 sold to readers, and linking (124) the ELM/KTT 10 sold to readers to the revised units of text to produce an updated ELM/KTT. Again, as before, linking changes and additions to the ELM/KTT may be done by installing symbolic anchors in each ELM/KTT, and symbolic links in each change or addition linking to the symbolic anchors in the ELM/KTT. Likewise, linking the ELM/KTT to changes or additions of text may be done by installing symbolic anchors in each change or addition, and symbolic links in each ELM/KTT lining to the symbolic anchors in each change or addition.

Updating an ELM/KTT may also require deleting one or more units of text of an original ELM/KTT sold to readers, and relinking the remaining units of text of the ELM/KTT sold to readers to produce an updated ELM/KTT.

The updated ELM/KTT, any additional units of text, and any changes, additions, and deletions to an ELM/KTT, may be packaged and sold to the readers in physical form, in electronic form, or in combined physical and electronic form.

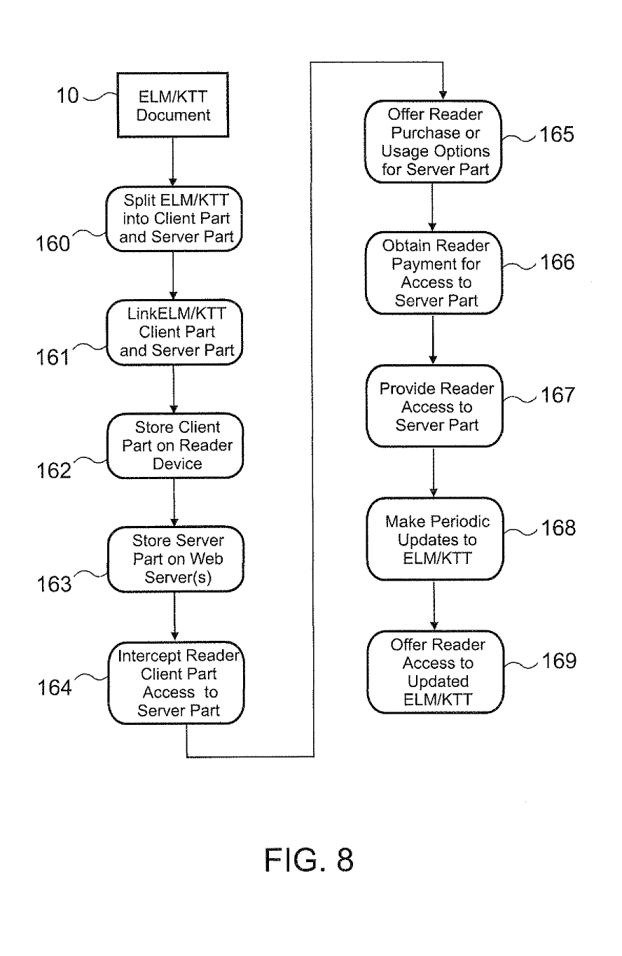

See FIG. 8. The present method and apparatus provide for selling the changes and additions of the original ELM/KTT by dividing (160) the original ELM/KTT 10 into a first part for the reader's system and one or more second parts to be stored on server systems. The present method and apparatus create (161) hypertext links between the first part and the second part, stores (162) the first part on a reader's electronic reading device, and stores (163) the second part on a Website accessible to the reader's electronic reading device. When a reader attempts to link to a component in the second part, the present method and apparatus intercept (164) attempted reader accesses from the first part to the second part stored on a server, and displays (165) to the reader attempting access a set of choices for purchase or use of the second part of the ELM/KTT. If the reader agrees to the terms of purchase or use, the present method and apparatus obtain (166) reader payment for said purchase or use and provides (167) reader access to the requested part of the ELM/KTT. To market further extensions and changes to the ELM/KTT, the present method and apparatus provide for periodic updating (168) the server-based parts of the ELM/KTT to provide added value to readers, and offers (169) accessing readers the purchase or use of further components for the ELM/KTT.

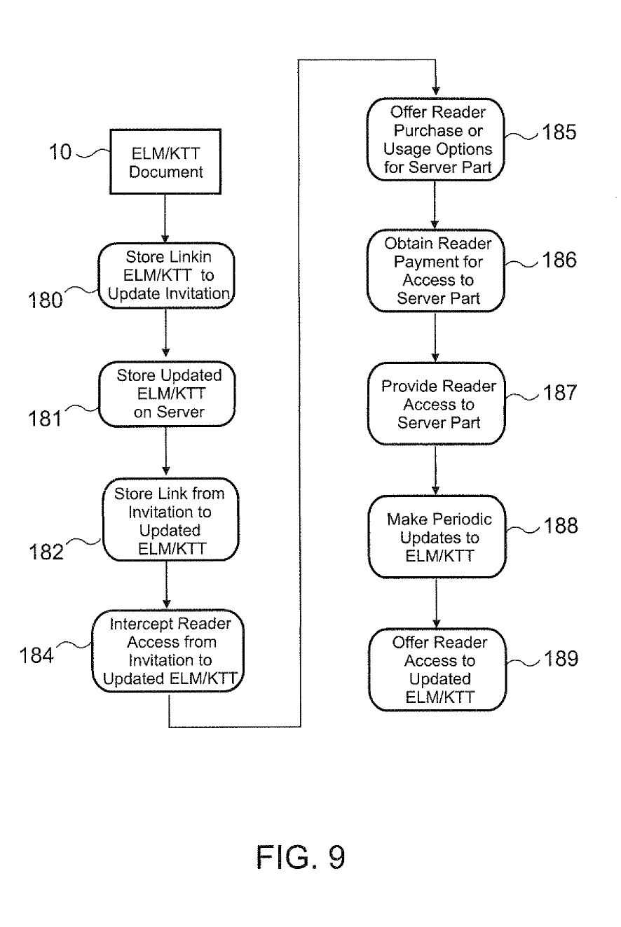

See FIG. 9. Selling the updated ELM/KTT in a complete form to the readers follows a process similar to that for the sale of changes and additions. The present method and apparatus first insert (180) in the original ELM/KTT 10 a hypertext link to a update invitation location stored on a Website accessible to the reader's electronic reading device, and stores (181) the updated ELM/KTT on a Website accessible to the reader's electronic reading device, adding (182) a hypertext link from the update invitation location to tie updated ELM/KTT on a Website accessible to the reader's electronic reading device. When a reader attempts to link to the updated ELM/KTT via the invitation link, the present method and apparatus intercept (184) attempted reader accesses from the update invitation location to the updated ELM/KTT, and displays (185) to the reader attempting access a set of choices for purchase or use of the updated ELM/KTT. As before, if the reader agrees to the terms of purchase or use, the present method and apparatus obtain (186) reader payment for said purchase or use, and provides (187) reader access to the updated ELM/KTT. To market subsequent versions of the ELM/KTT, the present method and apparatus provide for periodic updating (188) said updated ELM/KTT to offer a further-updated ELM/KTT to the accessing reader; and offers (189) the accessing reader the purchase or use of said further-updated ELM/KTT.

In a scene or unit trading embodiment, a reader may collect an entire narrative by gathering and trading for its component scene or unit cards, and the overall narrative then forms an extension of an ELM/KTT in electronic form. By gradually making scene or unit cards available in serial fashion, either in electronic or physical form, an author thereby develops interest and focuses attention on a continually-extending narrative line. Such interest and attention are enhanced by a full spectrum of packaging and presentation options now available for existing commodities: boxed sets, encrypted or coded texts, attractive graphical images, multimedia clips, colorful and dynamic decoration, toolsets for viewing, decoding, and transmitting, and more.

One type of packaging usable for scene or unit trading is the digital photographic image, which the present method and apparatus exploit by making scenes or units and other narrative components available for printing on a digital photo printer using paper or card stock designed for higher-quality reproduction of images. The purchaser downloads the acquired images of narrative components and prints them for use.

In this way, authors of prose enter a new realm of publishing, in which each small component of a narrative—a scene or unit—becomes a marketable entity by itself. The author and publisher then profit from the purchase of scene or unit information, at a scene-by-scene or unit level, instead of waiting for the entire finished product to emerge from the publishing process.

From use of the present method and apparatus, then, the author's (and publishler's) profit from the standalone scenes or units comes not from per-copy purchase, but from continued revision and extension of the works in an ELM/KTT, as described elsewhere, and new issuances for sale of the revisions and extensions. New versions of standalone scenes or units may be created and sold at any time. Narratives may be ‘rethreaded’ by issuing new sequencings for already-provided sets of standalone scenes or units. Some standalone scenes or units may be made available only in physical, printed form. This model for profiting from the ELM/KTT and its standalone scene or unit components replaces conventional publishing models through its dynamic and intimate connection of an author with his or her readership, and the exploitation of that connection.

1. An apparatus for selling electronic documents, comprising:
a plurality of client computer systems for reading electronic literary or instructional documents, each client computer system further comprising one or more processors, a user display interface component, one or more user input interface components, an external communications component and one or more memory components for holding an operating system, one or more software applications, and one or more electronic literary or instructional documents each comprising a plurality of components; and
a plurality of server computer systems for providing electronic literary or instructional documents to said client computer systems, each said server computer system further comprising one or more processors, a user display interface component, one or more user input interface components, an external communications component, and one or more memory components for holding an operating system, one or more software applications, and one or more electronic literary or instructional documents each comprising a plurality of components.
means for restricting access to said components of electronic literary or instructional documents stored in said server computer system; and
means for obtaining payment for access to said components of electronic literary or instructional documents stored in said server computer system.

2. The apparatus of claim 1, wherein the electronic literary or instructional document comprises:
a plurality of electronic text components stored in a client computer system;
a plurality of electronic text components stored in a server computer system;
a plurality of electronic text components stored in a portable computer memory device;
a plurality of hypertext links among the electronic text components;
means for restricting access to said electronic text components stored in a server computer system; and
means for obtaining payment for access to said electronic text components stored in a server computer system.

3. The electronic literary or instructional document of claim 1 comprising:
a plurality of electronic text components stored in a portable computer memory device; and
means for obtaining payment for access to said electronic text components.

4. The electronic literary or instructional document of claim 2 further comprising:
a plurality of printed text components.
a plurality of textual links among the printed text components;
a plurality of hybrid links between the electronic text components and the printed text components; and
means for obtaining payment for access to the printed text components.

5. The electronic literary or instructional document of claim 2 further comprising:
a plurality of printed text components.
a plurality of textual links among the printed text components;
a plurality of hybrid links between the electronic text components and the printed text components; and
means for obtaining payment for access to the printed text components.

6. The electronic literary or instructional document of claim 2 further comprising an electronic literary macramé.

7. The electronic literary or instructional document of claim 2 further comprising a knowledge transfer tool.

8. The apparatus of claim 1 wherein each client computer system is selected from the group consisting of:
a desktop computer system;
a portable computer system;
a portable electronic book;
a portable electronic game playing system;
a personal digital assistant;
a wireless telephone.

9. The apparatus of claim 1 wherein each server computer system is selected from the group consisting of:
a desktop computer system;
a portable computer system;
a portable electronic book;
a portable electronic game playing system;
a personal digital assistant;
a wireless telephone.

10. The apparatus of claim 2 wherein the portable computer memory device is selected from the group consisting of:
a compact flash memory chip;
a memory stick;
an electronic smart card;
a compact disk;
a DVD;
a magnetic diskette;
an optical memory device;
a magneto-optical memory device.

11. The apparatus of claim 2 wherein each electronic text component is selected from the group consisting of:
a digital text comprising words and symbols;
a digital image;
a digital audio file;
a digital video file;
a software program containing electronic text components for presenting said electronic text components to a reader.

12. The apparatus of claim 4 wherein each printed text component is selected from the group consisting of:
a bound set of pages displaying the content of the printed component;
an unbound set of pages displaying the content of the printed component;
a trading card displaying the content of the printed component;
a package displaying the content of the printed component;
a toy displaying the content of the printed component;
an edible item displaying the content of the printed component;
an art object displaying the content of the printed component;
a mounted display showing the content of the printed component; and
a garment displaying the content of the printed component.

13. The apparatus of claim 4 wherein each hybrid link is selected from the group consisting of:
a printed text linking from a first printed text component to a second printed text component;
a printed text linking from a printed text component to an electronic text component;
an electronic text linking from an electronic text component to a printed text component;
a coded printed text readable by an electronic device linking from a printed text component to an electronic text component.

14. The electronic literary or instructional document of claim 13 wherein the coded printed text readable by an electronic device comprises a scannable optical code.

15. A method for marketing and selling an electronic literary or instructional document, comprising the steps of:
providing copies of the original electronic literary or instructional document to readers;
making changes and additions to the original electronic literary or instructional document to produce an updated electronic literary or instructional document and one or more sets of the changes and additions to the electronic literary or instructional document;
providing copies of the updated electronic literary or instructional document for download or mailing;
providing copies of the changes and additions to the electronic literary or instructional document to readers;
selling the updated electronic literary or instructional document to the readers; and
selling the changes and additions of the original electronic literary or instructional document to the readers.

16. The method of claim 15 wherein the step of providing copies of the original electronic literary or instructional document to readers further comprises the steps of:
storing one or more components of the original electronic literary or instructional document in a set of electronic files for downloading to an electronic reading device; and
storing one or more components of the original electronic literary or instructional document in a set of electronic files for storage on a server computer for remote access by an electronic reading device.

17. The method of claim 15 wherein the step of providing copies of the original electronic literary or instructional document to readers further comprises the steps of:
storing one or more components of the original electronic literary or instructional document in physical form for physical transmission and reading; and
storing one or more components of the original electronic literary or instructional document in coded physical form for physical transmission and electronic reading by a decoding device.

18. The method of claim 15 wherein the step of making changes and additions to the original electronic literary or instructional document to produce an updated electronic literary or instructional document and a set of the changes to the electronic literary or instructional document further comprises the steps of:
storing one or more components of the updated electronic literary or instructional document in a set of electronic files for downloading to an electronic reading device; and
storing one or more components of the updated electronic literary or instructional document in a set of electronic files for storage on a server computer for remote access by an electronic reading device.

19. The method of claim 15 wherein the step of making changes and additions to the original electronic literary or instructional document to produce an updated electronic literary or instructional document and a set of the changes to the electronic literary or instructional document further comprises the steps of:
storing one or more components of the updated electronic literary or instructional document in physical form for physical transmission and reading; and
storing one or more components of the updated electronic literary or instructional document in coded physical form for physical transmission and reading by a decoding device.

20. The method of claim 15 wherein the step of making changes and additions to the original electronic literary or instructional document to produce an updated electronic literary or instructional document and a set of the changes to the electronic literary or instructional document further comprises the step of storing one or more components of the updated electronic literary or instructional document in a set of electronic files in a digital memory device for physical transmission and downloading to an electronic reading device.

21. The method of claim 15 wherein the step of making changes and additions to the original electronic literary or instructional document to produce an updated electronic literary or instructional document and a set of the changes to the electronic literary or instructional document further comprises the steps of:
storing one or more changes to the electronic literary or instructional document in a set of electronic files for downloading to an electronic reading device; and
storing one or more changes to the electronic literary or instructional document in a set of electronic files for storage on a server computer for remote access by an electronic reading device.

22. The method of claim 15 wherein the step of making changes and additions to the original electronic literary or instructional document to produce an updated electronic literary or instructional document and a set of the changes to the electronic literary or instructional document further comprises the steps of:
storing one or more changes to the electronic literary or instructional document in physical form for physical transmission and reading; and
storing one or more changes to the updated electronic literary or instructional document in coded physical form for physical transmission and reading by a decoding device.

23. The method of claim 15 wherein the step of making changes and additions to the original electronic literary or instructional document to produce an updated electronic literary or instructional document and a set of the changes to the electronic literary or instructional document further comprises the step of storing one or more changes to the electronic literary or instructional document in a set of electronic files in a digital memory device for physical transmission and downloading to an electronic reading device;

24. The method of claim 15 wherein the step of offering and selling the updated electronic literary or instructional document to the readers further comprises the steps of:
packaging the updated electronic literary or instructional document in physical form; and
selling the updated electronic literary or instructional document to readers in physical form.

25. The method of claim 15 wherein the step of offering and selling the updated electronic literary or instructional document to the readers further comprises the steps of:
packaging the updated electronic literary or instructional document in electronic form; and
selling the updated electronic literary or instructional document to readers in electronic form.

26. The method of claim 15 wherein the step of offering and selling the updated electronic literary or instructional document to the readers further comprises the steps of:
packaging the updated electronic literary or instructional document in combined physical and electronic form; and
selling the updated electronic literary or instructional document to readers in combined physical and electronic form.

27. The method of claim 15 wherein the step of making changes and additions to the original electronic literary or instructional document to produce an updated electronic literary or instructional document and one or more sets of the changes and additions to the electronic literary or instructional document further comprises the steps of:
authoring one or more additional units of text for the original electronic literary or instructional document;
linking the one or more additional units of text to each other;
linking said additional units of text to the original electronic literary or instructional document; and
linking the original electronic literary or instructional document to the additional units of text to produce said updated electronic literary or instructional document and said one or more sets of the changes and additions to the electronic literary or instructional document.

28. The method of claim 27 wherein the step of linking said additional units of text to the electronic literary or instructional document further comprises the steps of:
installing a symbolic anchor in each electronic literary or instructional document; and
installing a symbolic link in each additional unit of text, linking to said symbolic anchor.

29. The method of claim 27 wherein the step of linking the original electronic literary or instructional document to the additional units of text further comprises the steps of:
installing a symbolic anchor in each additional unit of text; and
installing a symbolic link in each electronic literary or instructional document, linking to said symbolic anchor.

30. The method of claim 27 further comprising the steps of:
packaging the additional units of text in electronic form; and
selling the additional units of text to readers in electronic form to provide the updated electronic literary or instructional document.

31. The method of claim 27 further comprising the steps of:
packaging the additional units of text in physical form; and
selling the additional units of text to readers in physical form to provide the updated electronic literary or instructional document.

32. The method of claim 27 further comprising the steps of:
packaging the additional units of text in combined physical and electronic form; and
selling the additional units of text to readers in combined physical and electronic form to provide the updated electronic literary or instructional document.

33. The method of claim 15 wherein the step of making changes and additions to the original electronic literary or instructional document to produce an updated electronic literary or instructional document and one or more sets of the changes and additions to the electronic literary or instructional document further comprises the steps of:
revising one or more units of text of said original electronic literary or instructional document sold to readers;
linking the revised units of text to the electronic literary or instructional document sold to readers; and
linking the electronic literary or instructional document sold to readers to the revised units of text to produce an updated electronic literary or instructional document.

34. The method of claim 33 wherein the step of linking the revised units of text to the electronic literary or instructional document further comprises the steps of:
installing a symbolic anchor in the electronic literary or instructional document; and
installing a symbolic link in the revised units of text to said symbolic anchor.

35. The method of claim 33 wherein the step of linking the electronic literary or instructional document sold to readers to the revised units of text further comprises the steps of:
installing a symbolic anchor in the revised units of text to the electronic literary or instructional document; and
installing a symbolic link in the electronic literary or instructional document to said symbolic anchor.

36. The method of claim 33 further comprising the steps of:
packaging the revised units of text in electronic form; and
selling the revised units of text in electronic form to readers to provide the updated electronic literary or instructional document.

37. The method of claim 33 further comprising the steps of:
packaging the revised units of text in physical form; and
selling the revised units of text in physical form to readers to provide the updated electronic literary or instructional document.

38. The method of claim 33 further comprising the steps of:
packaging the revised units of text in combined physical form and electronic form; and
selling the revised units of text in combined physical form and electronic form to readers to provide the updated electronic literary or instructional document.

39. The method of claim 15 wherein the step of making changes and additions to the original electronic literary or instructional document to produce an updated electronic literary or instructional document and one or more sets of the changes and additions to the electronic literary or instructional document further comprises the steps of:
deleting one or more units of text of an electronic document sold to readers; and
relinking the remaining units of text of the electronic literary or instructional document sold to readers to produce an updated electronic literary or instructional document.

40. The method of claim 39 further comprising the steps of:
packaging the updated electronic literary or instructional document in physical form; and
selling the updated electronic literary or instructional document in physical form to readers.

41. The method of claim 39 further comprising the steps of:
packaging the updated electronic literary or instructional document in electronic form; and
selling the updated electronic literary or instructional document in electronic form to readers.

42. The method of claim 39 further comprising the steps of:
packaging the updated electronic literary or instructional document in combined physical and electronic form; and
selling the updated electronic literary or instructional document in combined physical and electronic form to readers.

43. The method of claim 15 wherein the step of selling the changes and additions of the original electronic literary or instructional document to the readers further comprises the steps of:
dividing the original electronic literary or instructional document into a first part and a second part;
creating hypertext links between the first part and the second part;
storing the first part on a reader's electronic reading device;
storing the second part on a Website accessible to the reader's electronic reading device;
intercepting attempted reader accesses from the first part of the electronic literary or instructional document to the second part of the electronic literary or instructional document;
displaying to the reader attempting access a set of choices for purchase or use of the second part of the electronic literary or instructional document;
obtaining reader payment for said purchase or use;
providing reader access to said second part of the electronic literary or instructional document;
periodically updating said second part of the electronic literary or instructional document to provide added value to the accessing reader;
offering the accessing reader the purchase or use of further components for the electronic literary or instructional document.

44. The method of claim 15 wherein the step of selling the updated electronic literary or instructional document to the readers further comprises the steps of:
inserting in the original electronic literary or instructional document a hypertext link to a update invitation location stored on a Website accessible to the reader's electronic reading device;
storing the updated electronic literary or instructional document on a Website accessible to the reader's electronic reading device;
storing a hypertext link from the update invitation location to the updated electronic literary or instructional document on a Website accessible to the reader's electronic reading device;
intercepting attempted reader accesses from the update invitation location to the updated electronic literary or instructional document;
displaying to the reader attempting access a set of choices for purchase or use of the updated electronic literary or instructional document;
obtaining reader payment for said purchase or use;
providing reader access to the updated electronic literary or instructional document;
periodically updating said updated electronic literary or instructional document to provide a further-updated electronic literary or instructional document to the accessing reader; and
offering the accessing reader the purchase or use of said further-updated electronic literary or instructional document.
